(19) United States
(12) Patent Application Publication
(10) Pub. No.: US 2007/0076963 A1
(43) Pub. Date: Apr. 5, 2007

(54) Image transmission mechanism and method for implementing the same

(75) Inventor: Chien-hsing Liu, (US)

Correspondence Address: TROXELL LAW OFFICE PLLC, SUITE 1404, 5205 LEESBURG PIKE, FALLS CHURCH, VA, 22041, US

(73) Assignee: WELLSYN Technology, Inc.

(21) Appl. No.: 11/238,938

(22) Filed: Sep. 30, 2005

(51) Int. Cl. G06K 9/36

(52) U.S. Cl. 382/236

(57) ABSTRACT

The instant invention discloses an image transmission mechanism and a method applied on a remote control system for decreasing the data volume of video signals of at least one far computerized system transmitted to a console terminal over a network. The image transmission unit for analyzing motioned block includes a color space converter, an accumulator, a plurality of sum registers, and a motioned block detector. In each captured frame, the pixel data of each block is summed up to obtain a sum data that would be stored in a corresponding sum registers. By the motioned block detector, the total numbers of all motioned blocks in a frame, in comparison with a previous frame, is determined according to a sum table relied upon a minimal-area searching rule. Therefore, those will efficiently lessen image transmission over a limited bandwidth of a network.

### BACKGROUNG OF INVENTION

1. Field of the Invention

The present invention relates to an image transmission mechanism and method for implementing the same, and more particularly to an image transmission mechanism and method for decreasing image transmission volume over a limited bandwidth of a network.

2. Description of the Prior Art

Presently, an image monitoring technology is being widely utilized for various kinds of the fields, e.g. a public security or a remote networking control. With the remote networking control, for either a remote image inspection or remotely captured-image storage, it is essential but difficult to transmit a larger motioned image data over a limited transmission bandwidth from an image-generating terminal to a console (controlling) terminal. Therefore, it is a significant issue to reach how to raise data transmission performance, i.e. decreasing volumes of unnecessary image data. An ideal solution is proposed that from the same image a present frame is compared with a previous frame so as to achieve a varied image data (i.e. a pixel data) therebetween. Only the varied image data would be captured for transmission to a remote console terminal, rather than each sequential frame regardless of whether any variance occurs therein. As resulted, the transmitted image data might be capable of being mostly reduced.

However, this causes another significant issue happened that finding out a varied part between each pair of sequential frames generated from the same image must be efficient and rapid. Otherwise, an extreme complexly searching method for varied image data would results in a waste of time and inefficiency. In the other hand, an imprecisely searching method would obtain an inexact result, i.e. a distorted image outputted from the remote terminal.

A conventional searching method used in a remote control software, i.e. a known “VNC (Virtual Network Computing) ”, is introduced hereinafter, providing user's computer with required monitoring image from any other remote computer or device anywhere on the networking environment.

The VNC allows cross-platform and remote control between different types of computer. In applications, the VNC searches each rectangular set in varied pixel during comparison between two sequential frames (i.e. a first and second frames) in the same image. In a case of exemplar, initially within a second frame of a specified image A, each pixel from the left to right of a row is swept until a varied pixel appears with regard to the first frame. If there is not any one varied pixel appearing in the row, sweeping the other next rows will be performed as the same step. If there is a varied pixel found in the row, each of the other adjacent pixels in the same row is sequentially swept from the right of the varied pixel until none of the other varied pixel is found. After the row is swept, it is assumed that a sequential varied pixel sets S1 with a width “X” is established along a horizontal axis of the row. Then, each of the other rows adjacent to said row is sequentially swept to find whether a varied pixels set with a width “X” occurs until nothing meets this condition. After a plurality of rows of the second frame are swept, it is assumed that a sequential varied pixel sets Sn (n>1) with a width “X” and a height “Y” occurs along horizontal and vertical axes of the plurality of rows. A rectangular area of varied pixel sets is identical with X*Y.

Finally, a loop including all of the aforementioned steps is implemented until all the varied pixel sets Sn in the specified image A are found out. However, the well-known remote control software, such as VNC, can not efficiently reduce the transmission data when a large number of motioned blocks are not successive in a frame. Therefore, usage of the VNC can not exactly decrease data volume for transmission. It needs a better resolution against drawbacks of the conventional VNC searching method.

### SUMMARY OF INVENTION

To solve the aforementioned problems, it is therefore a primary objective of the present invention to provide an image transmission mechanism and method for implementing the same with uses of a minimal-area searching rule to analyze motioned blocks between sequential frames for less image transmission over a limited bandwidth of a network.

To achieve the aforementioned objective, the present invention discloses an image transmission mechanism for controlling video signals of at least one remote computerized system from a console terminal over a network.

The image transmission unit for analyzing motioned blocks in comparison between sequential frames derived from an image, includes a color space converter, an accumulator, a plurality of sum registers, and a motioned block detector. Meanwhile, the color space converter is configured to generate pixel data of each frame of the image. The accumulator is used to sum up the pixel data of each block specially grouped in the frame to achieve a sum data. Each of the plurality of sum registers is utilized to store the sum data. The motioned block detector determines the total numbers of all motioned blocks in each frame, according to a sum table relied upon a minimal-area searching rule.

Beside, the present invention discloses a method for implementing the image transmission unit, comprises the following steps:

capturing at least one first video signal to constitute a first frame with pixel data of an image;

summing up the pixel data of the first frame to achieve a first sum data, and then storing the first sum data into a first sum register of the image transmission unit;

compressing the first frame, and then sending the compressed first frame to a network;

capturing at least one second video signal to constitute a second frame with pixel of the image;

summing up pixel data of each block specially grouped the second frame to achieve a second sum data, and then storing the second sum data into a second sum register;

analyzing which block becomes motioned in the second frame with regard to the first frame, with use of a sum table relied on a minimal-area searching rule;

compressing the motioned blocks in the second frame, and then sending the compressed motioned blocks in the second frame to a network; and

replacing the first sum data by the second sum data stored in the first sum register.

### BRIEF DESCRIPTION OF DRAWINGS

FIG. 1 illustrates a schematic diagram of a remote control system according to the present invention;

FIG. 2 illustrates a schematic diagram of a remote computer in accordance with the present invention;

FIG. 3 illustrates a schematic diagram of an image transmission unit applied on the remote computer;

FIG. 4 illustrates a flow chart of a method for image transmission with use of image transmission unit; and FIG. 5 illustrates a flow chart representing a minimal-area search rule.

FIG. 6˜FIG. 17 illustrate several examples for analyzing motioned blocks.

### DETAILED DESCRIPTION

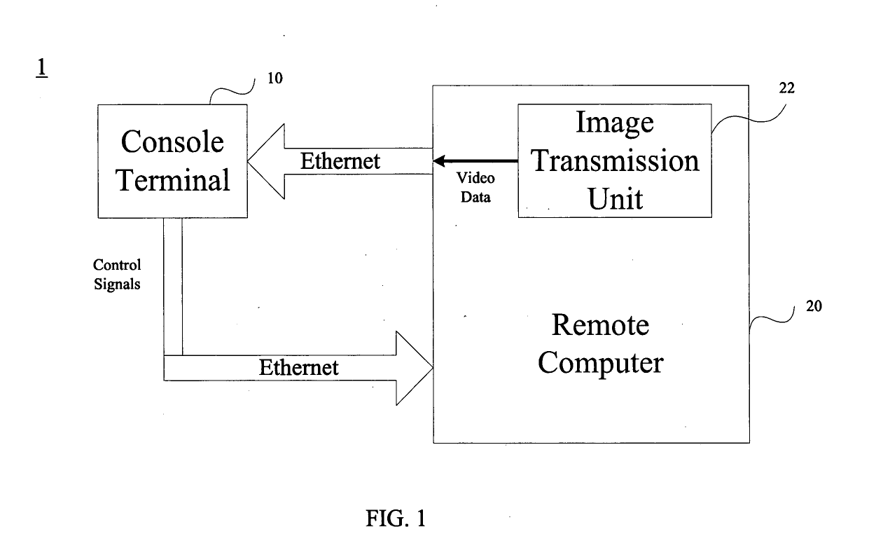

Firstly referring to illustrated in FIG. 1, a remote control system 1 according to the present invention, includes a console terminal 10, at least one remote computer 20 and an image transmission unit 22 disposed within the remote computer 20, for controlling keyboard, mouse and video (KVM) signals between the remote computer 20 and the console terminal 10 over a network (e.g. Ethernet). The user manipulates the console terminal 10 to-transmit several control signals to the remote computer 20, i.e. keyboard, mouse signals. Oppositely, the remote computer 20 transmits video data to its image transmission unit 22, and then the video data is processed by the image transmission unit 22 and is transmitted to the console terminal 10 over the Ethernet network. A series of video data can be gathered to constitute an image frame. The remote control system 1 is possibly realized as a system-on chip or a circuitry within a KVM switch compatible with IPMI (Intelligent Platform Management Interface) system.

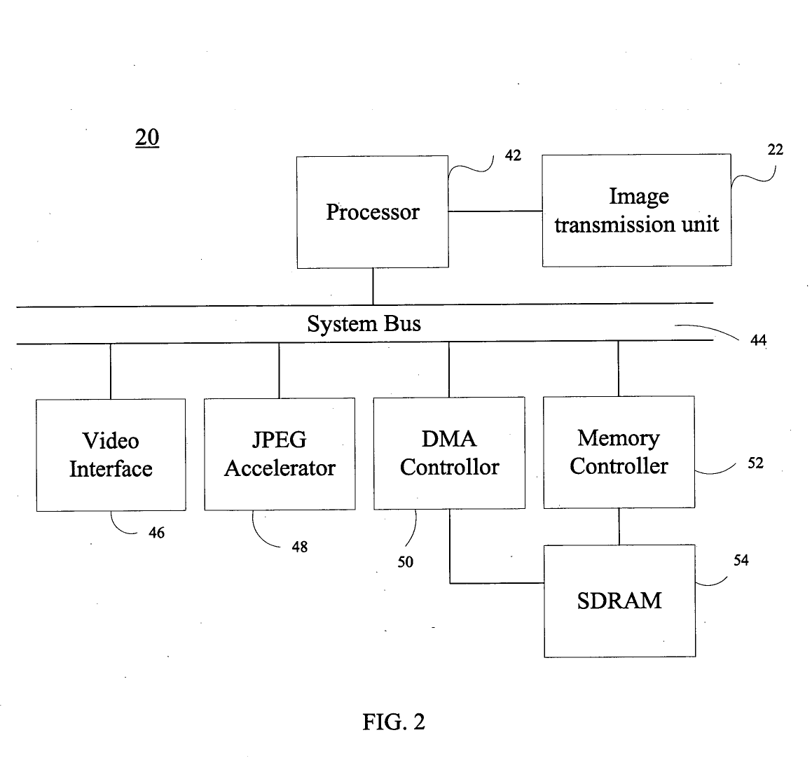

Please referring to FIG. 2, the remote computer 20 mainly includes a processor 42, a video interface 46, a JPEG accelerator 48, a DMA controller 50, and a memory controller 52, and the image transmission unit 22 coupled to the processor 42, each which are linked to a system bus 44 for interactive communication.

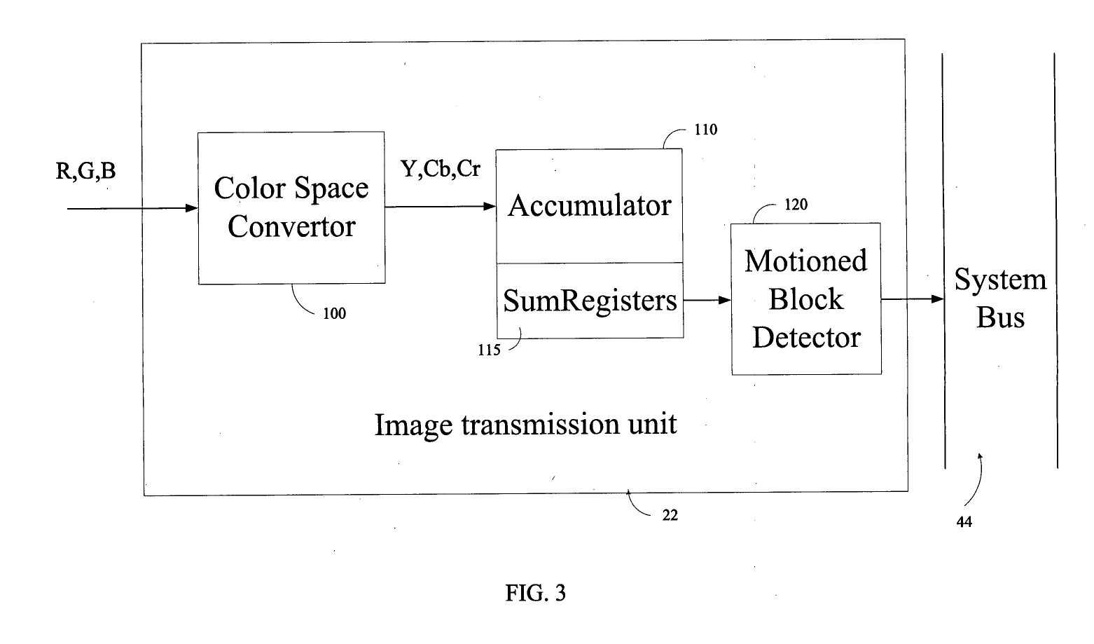

Further referring to FIG. 3, the image transmission unit 22 according to the present invention, for monitoring and analyzing motioned blocks between each two sequential frames (e.g. a first and second frames) generated from an image, has a color space converter 100, an accumulator 110, a plurality of sum registers 115, and a motioned block detector 120. Meanwhile, the color space converter 100 is configured to receive R, G, B data captured from the video interface 40 and digitally transforms the R, G, B data into pixel data with regard to the frame, i.e. a known Y, C_{b}, Cᵣ data as digitalized luminance and chrominance signals. The accumulator 110 is configured to sum up the pixel data of each block specifically grouped in the frame to achieve a sum data for the each block of the frame. Each of the plurality of sum registers 115 is utilized to store the sum data of the each block of the frame (i.e. the first and second frames) wherein a driver incorporated with a program can drive the DMA controller 50 (See FIG. 2) to access the sum registers 115 for further storing the sum data to a memory unit 54, i.e. SDRAM, via the memory controller 52. The motioned block detector 120 determines the total numbers of blocks which become motioned in comparison between each two sequential first and second frames, according to a H/W (Height/Width) sum table relied upon a minimal-area searching rule (detailed later), and compresses the motioned blocks in the second frame with a block-based JPEG image format for lessening image transmission.

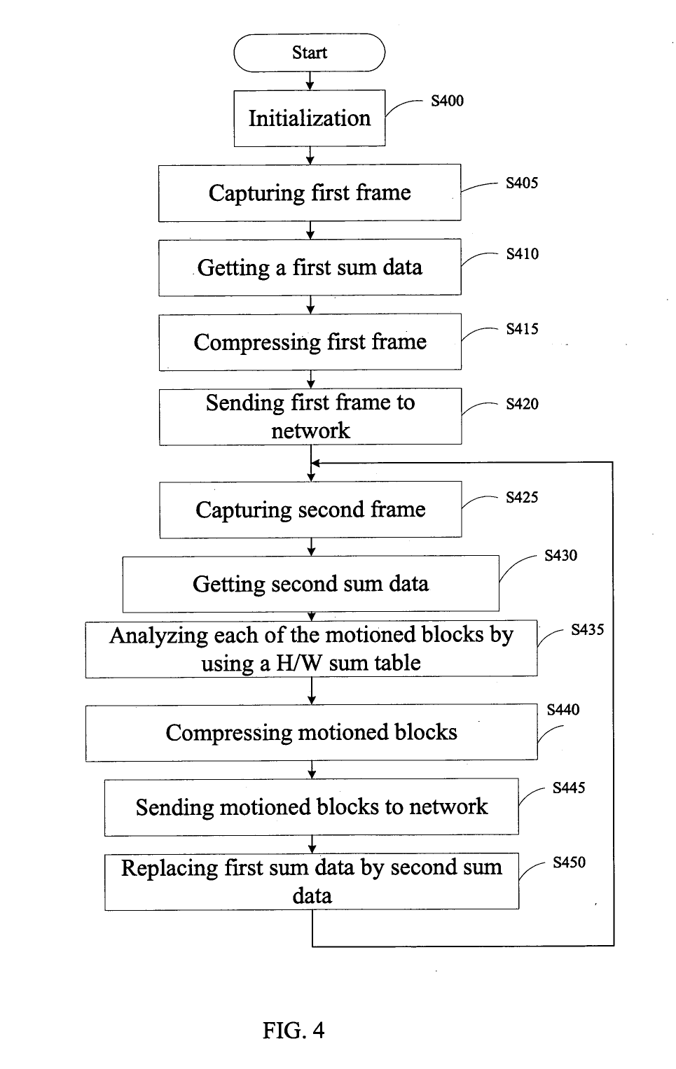

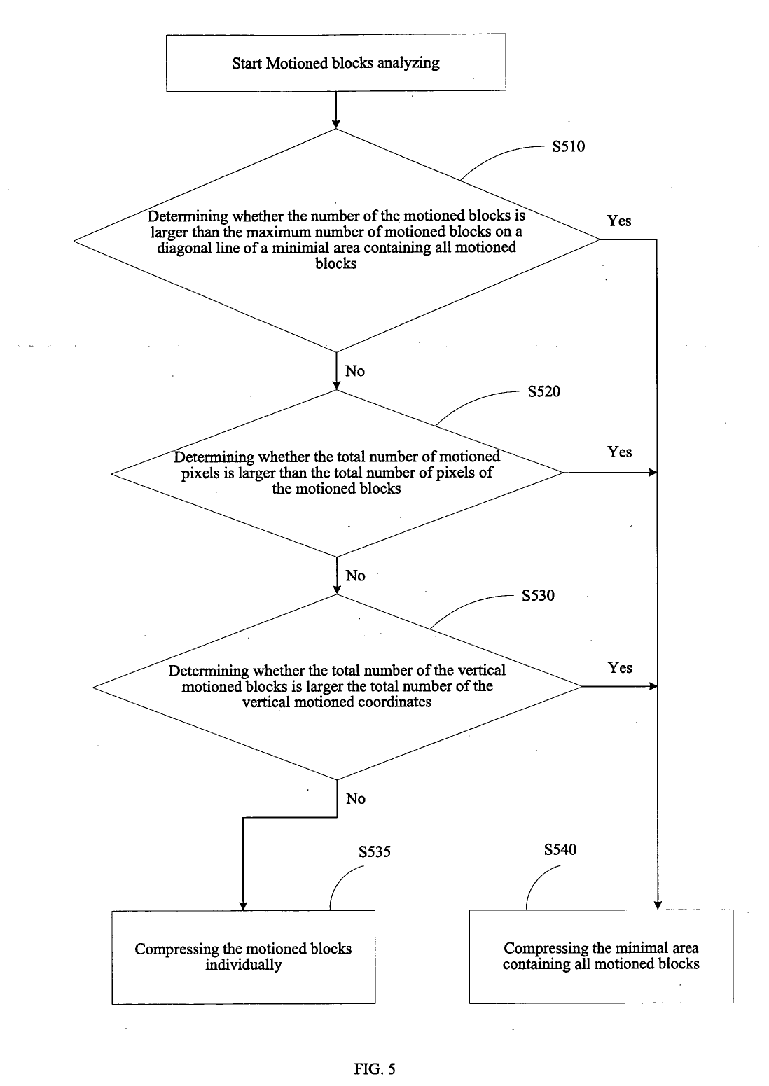

Please refer to FIG.4. In application, a method of image transmission according to the present invention, with usage of the image transmission unit 22, comprises the following steps:

In step S400, initializing the remote control system for image transmission;

In step S405, capturing some first video signals (i.e. R, C; B data) to be transformed into a first frame with pixel data of an image by a color space converter;

In step S410, summing up the pixel data of the first frame by an accumulator to achieve a first sum data, and then storing the first sum data into a first sum register of the image transmission unit for establishing a first sum table therein;

In steps S415 & S420, compressing the first frame with a block-based JPEG image format, and then sending the compressed first frame to a network for image transmission;

In step S425, capturing some second video signals (i.e. R, G, B data) to be transformed into a second frame with pixel data of the image by the color space converter, sequential to the first frame;

In step S430, summing up pixel data of each block specifically grouped in the second frame by the accumulator to achieve a second sum data, and then storing the second sum data into a second sum register for establishing a second sum table therein;

In step S435, analyzing which block becomes motioned in the second frame, in comparison with the first frame, by a motioned block detector with use of a H/W sum table relied on a minimal-area searching rule;

In steps S440 & S445, compressing the motioned blocks in the second frame with a block-based JPEG image format, and then sending the compressed motioned blocks in the second frame to a network for lessening image transmission; and

In step S450, replacing the first sum data by the second sum data stored in the first sum register, by way of copying the second sum table to replace the first sum table.

Further referring to FIG. 5, a method of implementing the minimal-area searching rule to analyze volume of the motioned blocks of the second frame in need of transmission wherein the total number of minimal-area motioned blocks are pre-found, further includes the following steps of:

In step S510, determining whether the total number of the motioned blocks in a specified minimal area is larger than a maximal number of motioned blocks along a diagonal line of the specified minimal area accommodating all motioned blocks therein. It denotes that the total number of the motioned blocks in the specified minimal area is too many. If so, compressing the specified minimal area as implementing a step S540 for enhancing efficiency; otherwise, implementing a next step S520;

In step S520, determining whether the total number of motioned pixels data is larger than the total number of pixels data of the motioned blocks wherein the pixel data can be considered as a minimal-area block. It means that although the total number of the motioned blocks in the specified minimal area is not too many, the pixel data of the motioned blocks are discontiguous. If so, compressing the specified minimal area as implementing the step S540 for enhancing efficiency; otherwise, implementing a next step S530;

In step S530, determining whether the total number of the vertical motioned blocks is larger than the total number of the vertical motioned coordinates. If so, compressing the specified minimal area as implementing the step S540; otherwise, implementing a next step S535;

In step S535, individually compressing each of the motioned blocks for lessening image transmission; and

In step S540, compressing the minimal area containing all motioned blocks In conclusion, the image transmission mechanism and method according to the present invention uses a minimal-area searching rule to analyze motioned blocks between sequential frames for less image transmission over a limited bandwidth of a network.

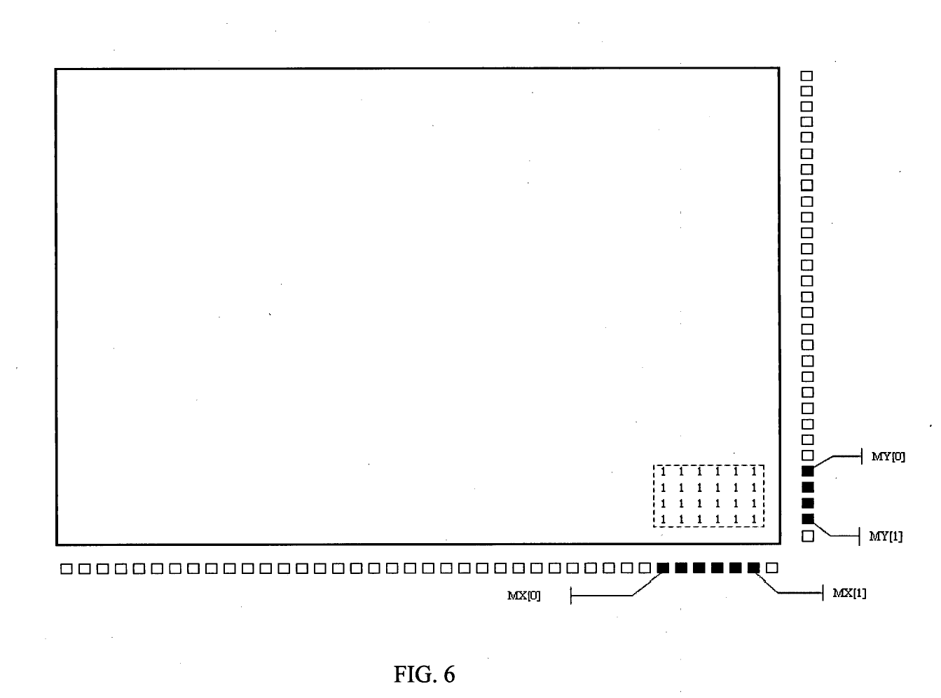

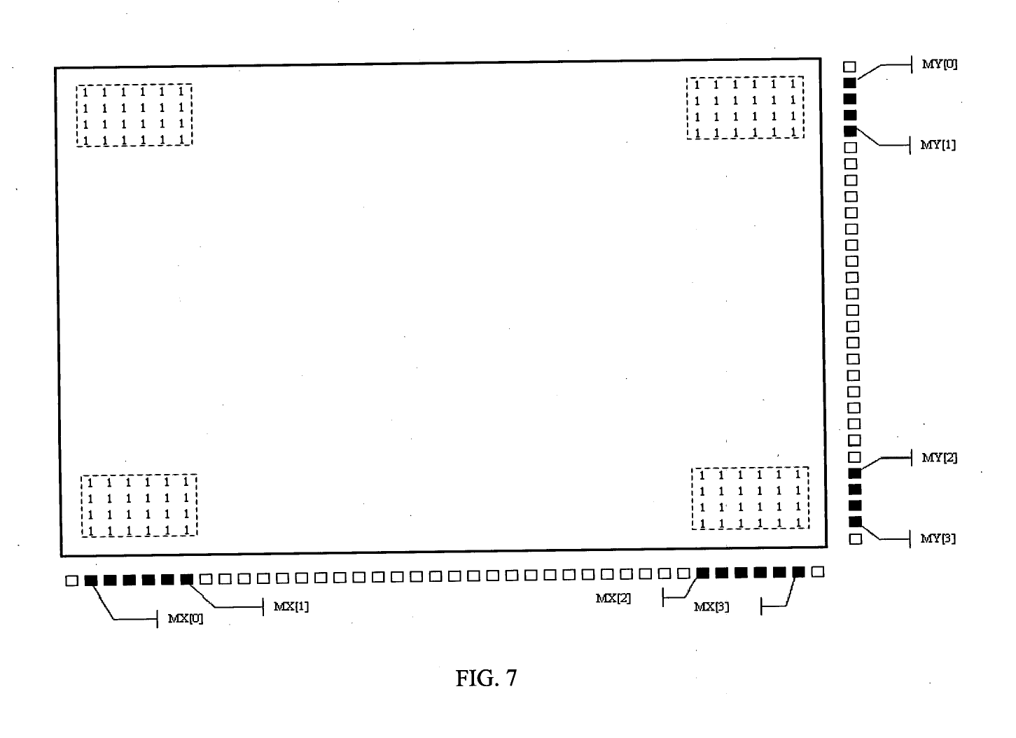

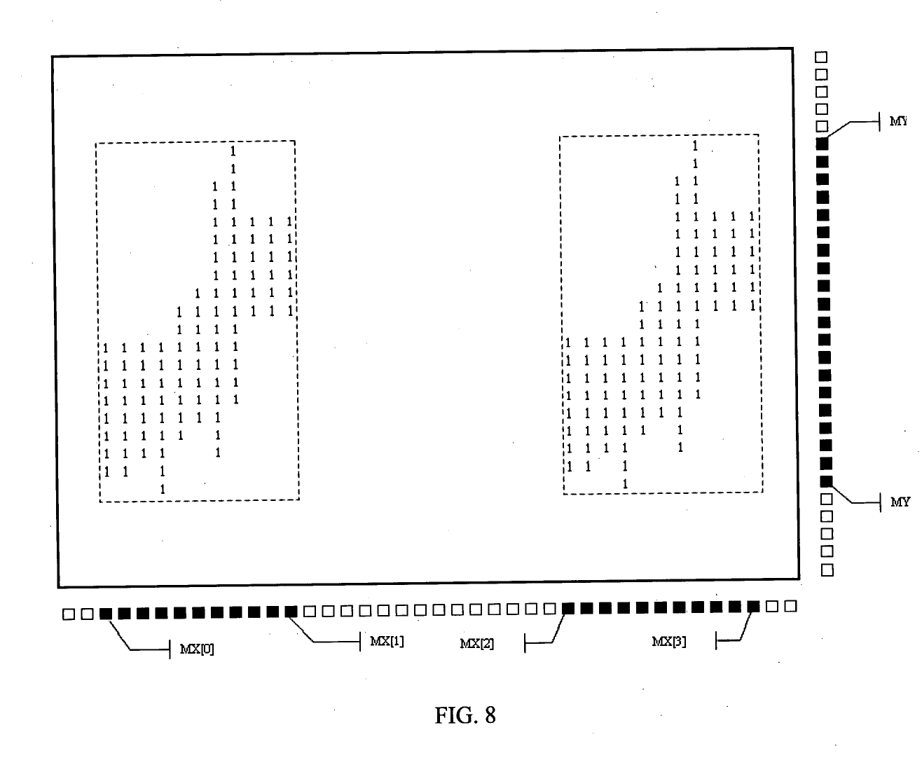

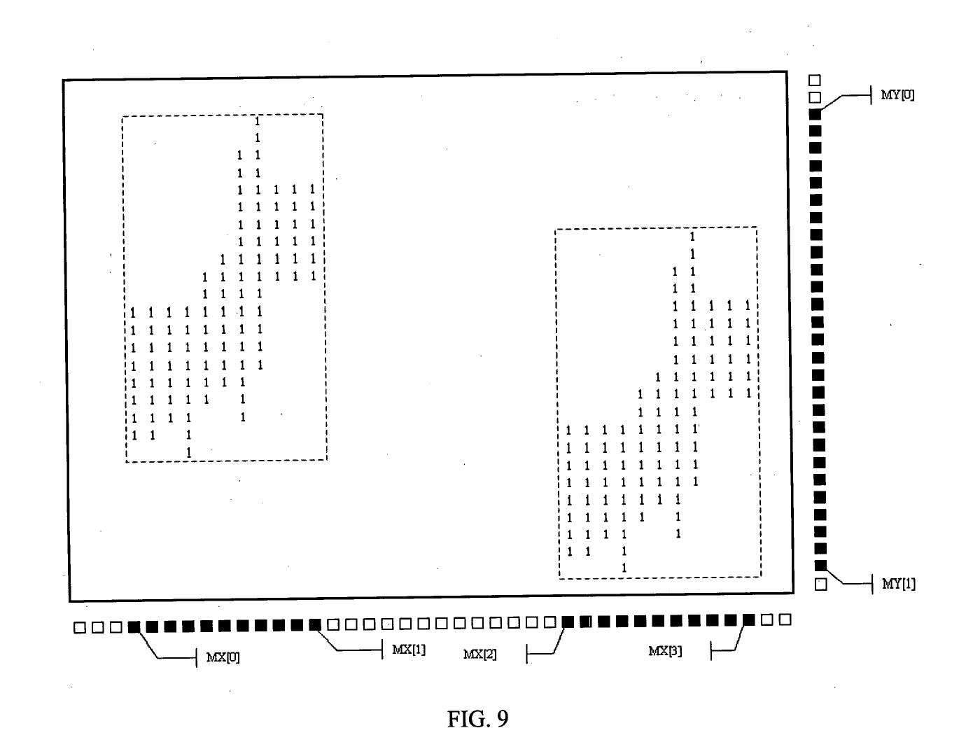

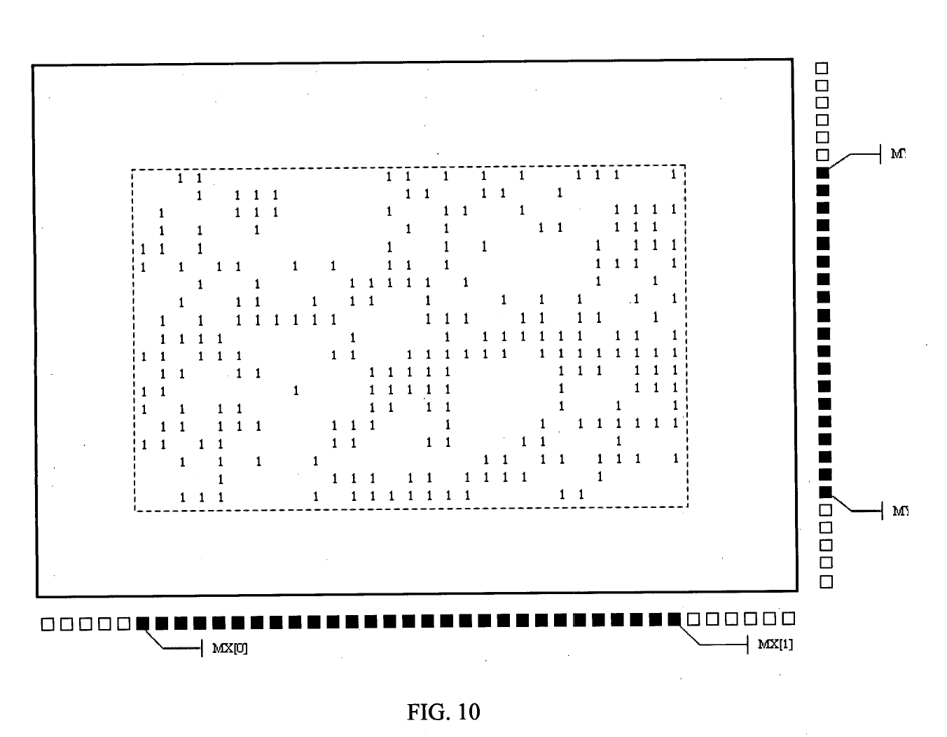

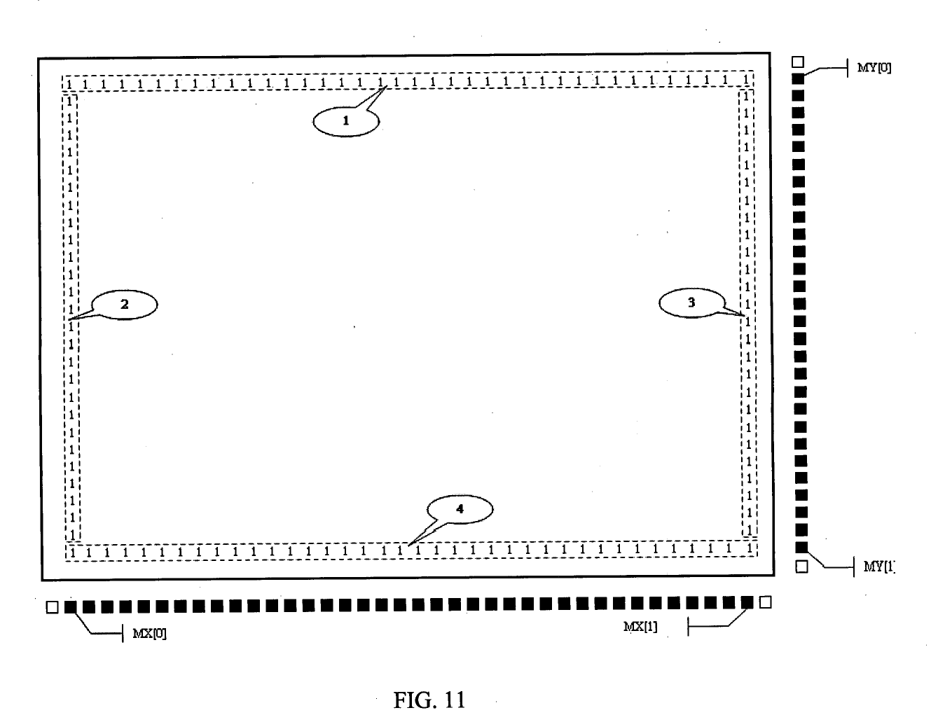

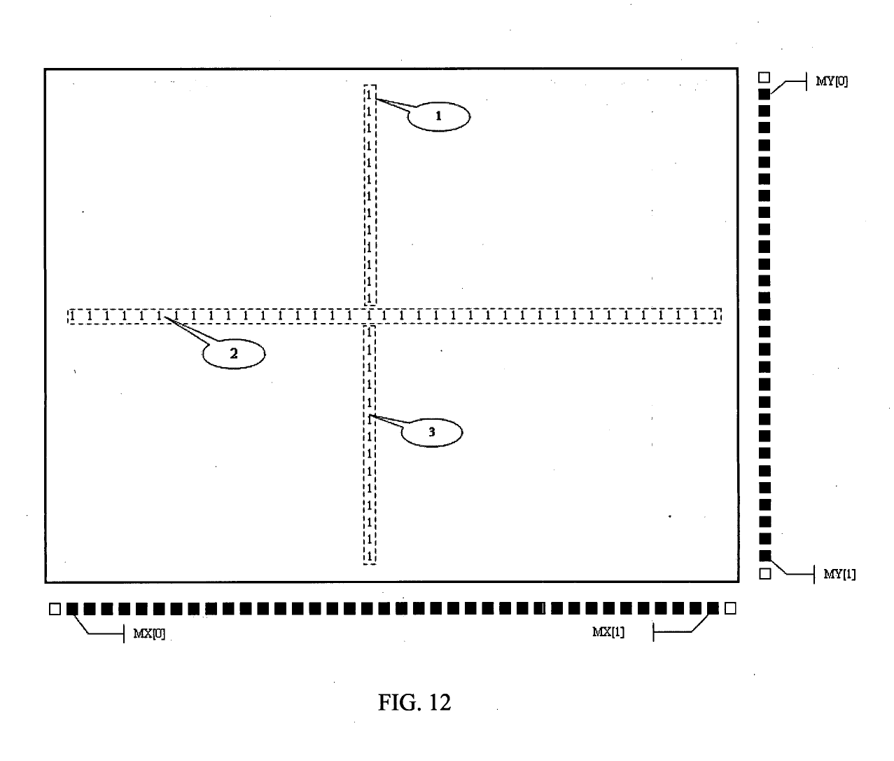

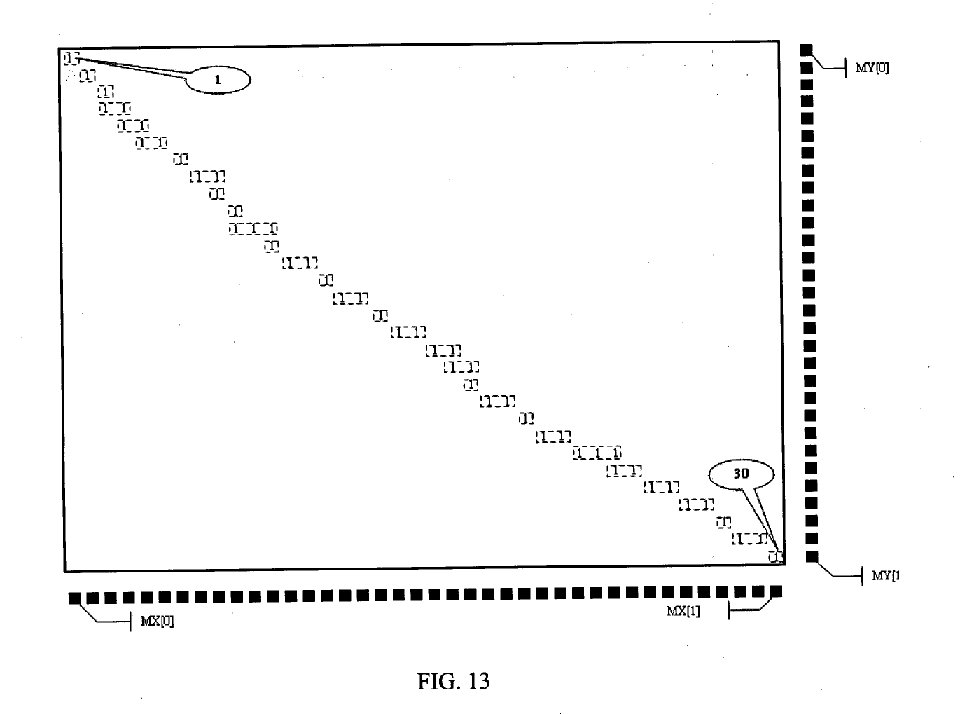

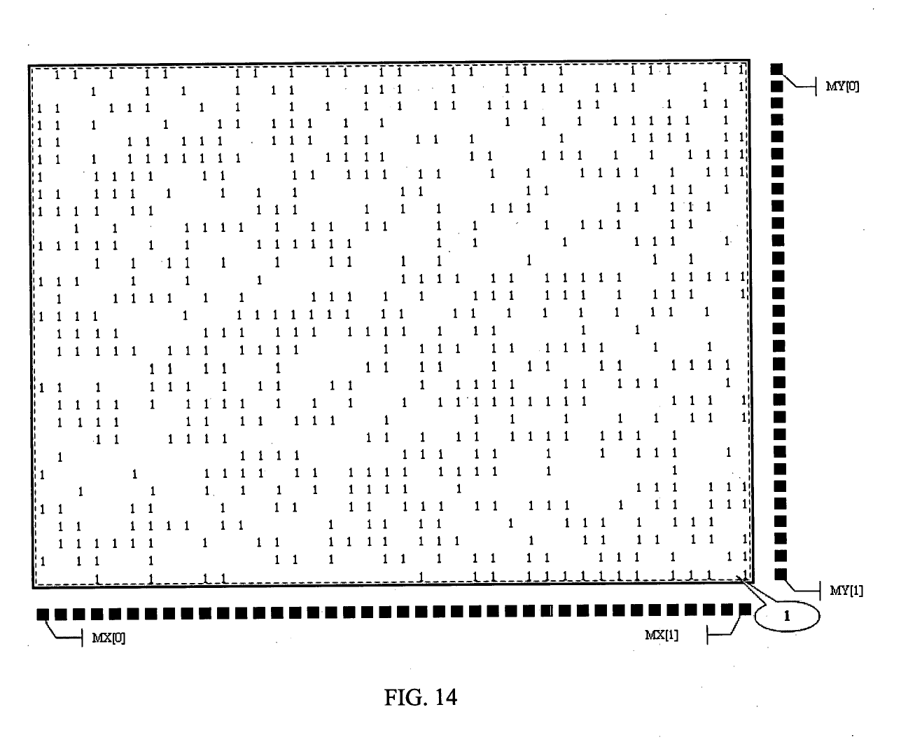

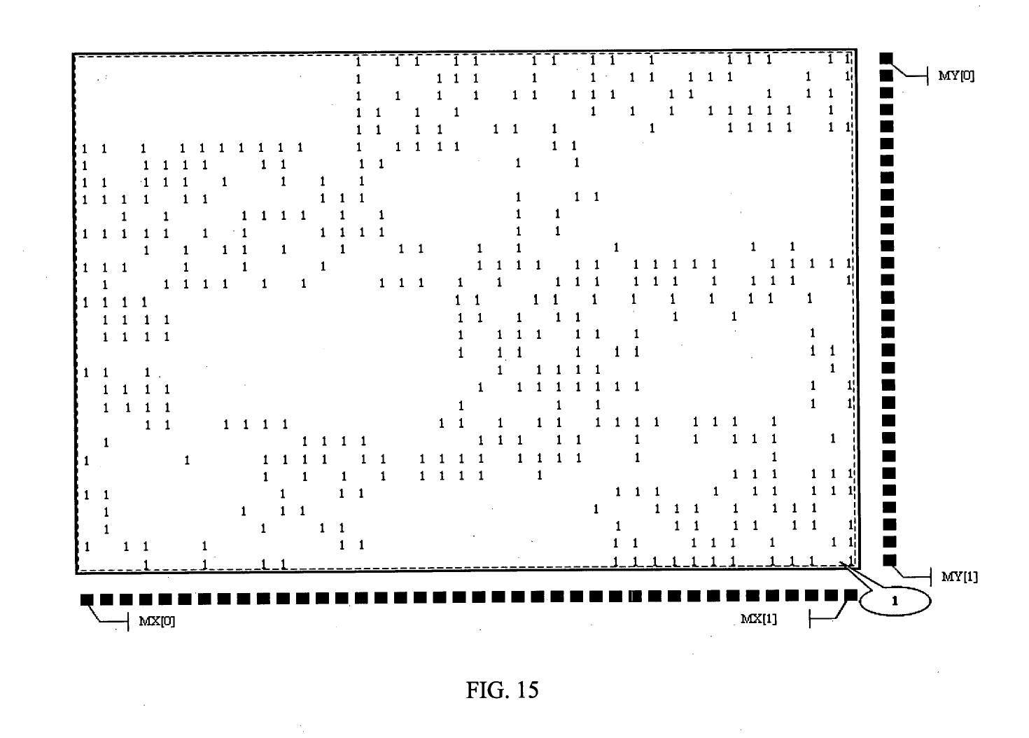

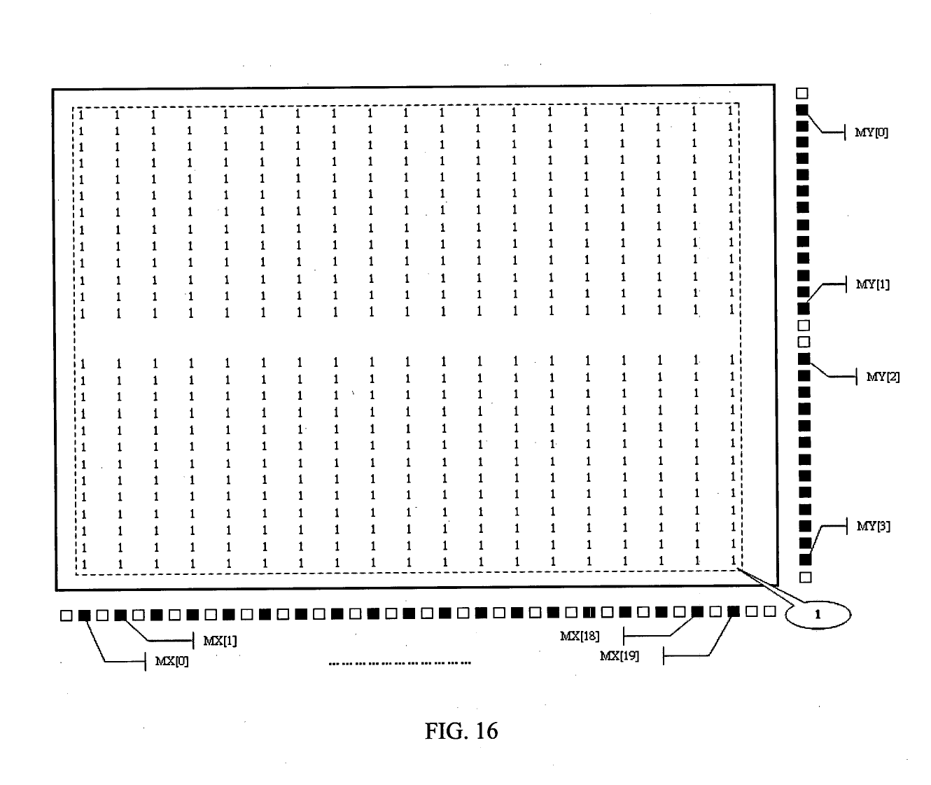

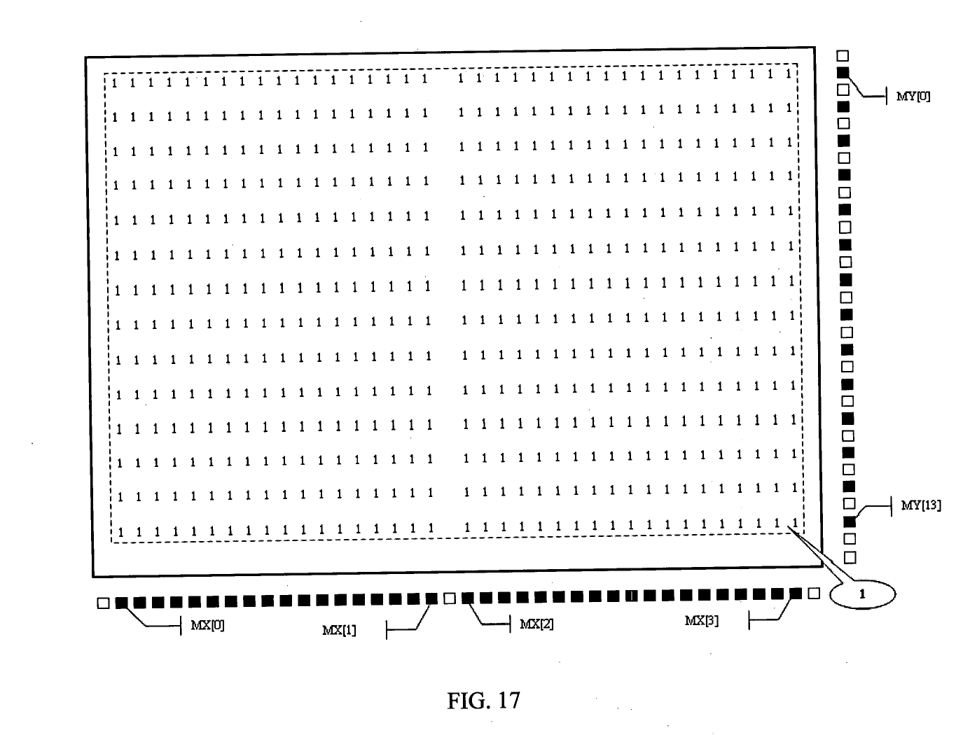

FIG. 6˜FIG. 17 respectively illustrate some examples by implementing minimal-area searching rule to analyze motioned blocks between each pair of sequential first and second frames in accordance with the present invention. Each motioned block in there figurations is indicated as filled with “1” and marked by a broken line. In FIG. 6, since the numbers of motioned blocks or motioned pixels cannot meet the criteria from said steps S510 to S530 shown in FIG. 4, the image transmission unit finds only one motioned block and therefore compresses it for transmission. In FIG.7˜FIG. 9, similarly, the image transmission unit will find four, two and two motioned areas, respectively. In FIG. 10, since number of the motioned pixels is larger than total number of pixels of the motioned blocks (see step S520), the image transmission unit finds only one motioned area. In FIG. 11, as a result that the number of the vertical motioned blocks is larger than the total number of the vertical motioned coordinates (see step S530), the image transmission unit finds four motioned areas. In FIG. 12 and FIG. 13, similarly, the image transmission unit will find three and thirty motioned areas respectively. In FIG. 14 and FIG. 15, since number of the motioned pixels is larger than total number of pixels of the motioned blocks (step S520), the image transmission unit finds only one motioned area respectively. In FIG. 16 and FIG. 17, since the number of the vertical motioned blocks is larger than the total number of the vertical motioned coordinates (step S530), the image transmission unit finds only one motioned area respectively.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image transmission mechanism for analyzing blocks grouped in each image frame, the image transmission mechanism comprising:
a color space converter receiving each video signal to constitute a specific frame with pixel data;
an accumulator capable of summing up pixel data of each block grouped in the frame to obtain a corresponding sum data;
a sum register storing the sum data of the frame; and
a motioned block detector detecting which block becomes motioned in comparison between each pair of sequential frames;
wherein the motioned block detector further determines the number of motioned blocks to be transmitted, according to a minimal-area searching rule.

2. The mechanism of claim 1, wherein the minimal-area searching rule comprising the steps of:
finding the total number of minimal-area motioned blocks;
comparing the total number of the motioned blocks with a maximum number of motioned blocks on a diagonal line of a minimal area containing all motioned blocks.

3. The mechanism of claim 2, wherein the minimal-area searching rule further comprises a step of comparing the total number of motioned pixels with the total number of pixels of the motioned blocks.

4. The mechanism of claim 3 wherein the minimal-area searching rule further comprises a step of comparing the total number of the vertical motioned blocks with the total number of the vertical motioned coordinates.

5. A method for analyzing motioned blocks during image transmission, comprising the steps of:
capturing a first frame with pixel data for an image;
summing up the pixel data of the first frame to obtain a first sum data;
compressing the first frame;
sending the compressed first frame to a network;
capturing a second frame with pixel data;
summing up pixel data of each block grouped in the second frame to obtain a second sum data;
determining number of blocks which become motioned in the second frame with respect to the first frame by a motioned block detector, according to a minimal area searching rule;
compressing the motioned blocks;
sending the compressed motioned blocks to the network; and
replacing the first sum data by the second sum data.

6. The method as described in claim 5 wherein the minimal-area searching rule comprises the steps of:
finding the total number of minimal-area motioned blocks;
comparing the total number of the motioned blocks with a maximum number of motioned blocks on a diagonal line of a minimal area contained all motioned blocks.

7. The method as described in claim 6 wherein the minimal-area searching rule further comprises a step of comparing the total number of motioned pixels with the total number of pixel data of the motioned blocks.

8. The method as described claim 7 wherein the minimal-area searching rule further comprises a step of comparing the total number of the vertical motioned blocks with the total number of the vertical motioned coordinates.
